(19) United States
(12) Patent Application Publication
(10) Pub. No.: US 2021/0260469 A1
(43) Pub. Date: Aug. 26, 2021

(54) Quiz Game Processing Method and System

(71) Applicant: JIANGSU FUZAMEI TECHNOLOGY CO.,LTD., SUZHOU (CN)

(72) Inventors: Sijin WU, SUZHOU (CN); Zhiwen WANG, SUZHOU (CN)

(21) Appl. No.: 17/256,630

(22) PCT Filed: Jun. 20, 2019
(86) PCT No.: PCT/CN2019/092155

§ 371 Date: Dec. 28, 2020

(30) Foreign Application Priority Data
Jun. 29, 2018 (CN) 201810697418.0

(51) Int. Cl. A63F 9/18; A63F 13/75; G07F 17/32; H04L 9/32

(52) U.S. Cl. CPC A63F 9/183; A63F 13/75; H04L 2209/38; H04L 9/3236; A63F 2300/8064; G07F 17/3244

(57) ABSTRACT

A quiz game processing method and system thereof includes the following steps. Receive a quiz game order releasing request information sent by a first party terminal and release a quiz game order according to the quiz game order releasing request information. The quiz game order releasing request information includes a first quiz game content, a first hash value of a computation operation result obtained by a specified first operation performed on a random value, and a second hash value of the random number. Receive a quiz game request information sent by one or more second party terminals in response to the quiz game order. Trigger a quiz game smart contract. The quiz game request information includes a second quiz game content. Monitor, by the quiz game smart contract, whether the first party terminal releases a random value within a predetermined period of time and generate a quiz game result according to a monitoring result. By locking the random value, it is guaranteed that before the random value is released, no one other than the one held the random value knows the first quiz game content so as to avoid collusion and collateral cheating.

### BACKGROUND OF THE PRESENT INVENTION

### Field of Invention

The present application relates to the technical field of computer information and, in particular, to a quiz game processing method and system, device, and storage medium.

### Description of Related Arts

At present, the common online quiz games on the Internet require an agent computer to determine win or lose. Since the network has a time delay, so on the Internet cannot be done at the same time to show the content of the quiz game content. General solution is that one party firstly generates the quiz game content, and then inform the third party agent computer what content has been generated while the third party agent computer keeping confidential. Thereafter, another party generates another quiz game content and the third party agent computer computes out a result according to an algorithm to determine a quiz game result between the both parties. However, such solution has great drawbacks of failing to guarantee that the third party agent computer is fair and impartial, and to prevent the third party agent computer from falsifying the quiz game content and cheating along with one of the two parties.

### SUMMARY OF THE PRESENT INVENTION

In view of the above-mentioned drawbacks or disadvantages of the prior art, it would be desirable to provide a fair and impartial quiz game processing method and system, device, and storage medium.

In a first aspect, the present invention provides a quiz game processing method, including:

receiving a quiz game order releasing request information released from a first party terminal, releasing a quiz game order according to the quiz game order releasing request information, and recording the quiz game order releasing request information in a blockchain, wherein the quiz game order releasing request information includes a first quiz game content and a first hash value of a computing result obtained through a specified first computation of random number and a second hash value of random number;

receiving a quiz game request information released from one or more second party terminals in response to the quiz game order, triggering a quiz game smart contract and recording the quiz game request information in the blockchain, wherein the quiz game request information includes a second quiz game content; and

monitoring whether the first party terminal releases a random value through the quiz game smart contract within a predetermined period of time and generating a quiz game result according to a monitored result.

Further, if the random value released from the first party terminal is received within the predetermined period of time, process a first computation to prestored selectable choices of quiz game contents and process a hash computation to a computation result of the first hash computation to obtain one or more third hash values. Determine the first quiz game content by comparing the first hash value and the third hash value and generate the quiz game result by comparing the first quiz game content with the second quiz game content.

If no random value is received from the first party terminal within the predetermined period of time, determine a winning for the second party terminal directly and generate the quiz game result.

Further, if the random value and the first quiz game content are received from the first party terminal within the predetermined period of time, verify the first quiz game content according to the random value, the first hash value and the second hash value, and determine and generate the quiz game result by comparing the first quiz game content and the second quiz game content if the verification of the first quiz game content is correct.

If no random value and the first quiz game content is received within the predetermined period of time, determine a winning for the second party terminal directly and generate the quiz game result.

Further, the quiz game order releasing request information further comprises a first quiz game reward information of a first quiz game award, and the quiz game request information further comprises a second quiz game reward information of a second quiz game award.

The quiz game processing method further comprises a step of releasing awards to a quiz game winner for the first and second party terminals according to the first quiz game reward information, the second quiz game reward information and the quiz game result.

Further, the quiz game order releasing request information further comprises a security deposit information, and that the step of determining the winning for the second party terminal and generating the quiz game result directly further comprises:

releasing a security deposit to the second party terminal according to the security deposit information.

Further, the quiz game order releasing request information is generated by a private key signature held by the first party terminal, and the quiz game request information is generated by a second private key signature held by the one or more second party terminals, wherein the quiz game order releasing request information and the quiz game request information are recorded on the blockchain.

In a second aspect, the present invention also provides a quiz game operation device including:

a first information receiving unit, receiving a quiz game order releasing information from a first party terminal and releasing a quiz game order according to the quiz game order releasing information, wherein the quiz game order releasing information includes a first quiz game content and a first hash value of random value of a computation result of a specific first computation, and a second hash value of random value;

a second information receiving unit, receiving a quiz game request information from one or more second party terminals in response to the quiz game request information of the quiz game order; and

a monitoring unit, arranged for monitoring whether the first party terminal releases the random value within a predetermined period of time through a quiz game smart contract, so as to generate a quiz game result according to a monitoring result.

Further, the monitoring unit further comprise:

a determining sub-unit, arranged for processing a first computation to prestored selectable choices of quiz game contents and the random value if the random value released from the first party terminal is received within the predetermined period of time, processing a hash computation to a computation result of the first hash computation to obtain one or more third hash values, determining the first quiz game content by comparing the first hash value and the third hash value, and generating the quiz game result by comparing the first quiz game content with the second quiz game content, wherein if no random value and the first quiz game content are received within the predetermined period of time, determine a winning for the second party terminal and generate the quiz game result directly, wherein if the random value and the first quiz game content generated from the first party terminal is received within the predetermined period of time, verify the first quiz game content according to the random value, the first hash value and the second hash value, and determine and generate the quiz game result by comparing the first quiz game content and the second quiz game content if the verification of the first quiz game content is correct, wherein if no random value and the first quiz game content is received within the predetermined period of time, determine a winning for the second party terminal directly and generate the quiz game result.

Further, the quiz game processing device further comprises a reward releasing unit, arranged for releasing award to a winner of the first or second party terminal according to one or more predetermined rules, wherein if no random value S is received from the first party terminal within the predetermined period of time, the second party terminal is determined to be the winner directly and a first quiz game award is totally released to the second party terminal, wherein if the random value is generated, the second party terminal is determined to be the winner directly and a first quiz game award is totally released to the second party terminal.

In other embodiments of the present invention, a quiz game processing method and system thereof is provided for locking the random value S, so as to ensure that before the random value S is released, no one other than the one who holds the first quiz game content could know the quiz game content, preventing collusion and collateral cheating.

In some embodiments of the present invention, a quiz game processing method and system thereof is provided for providing quiz game award and security deposit (such as rewarding point and the like) that before the random value is released by the first party terminal, the quiz game award and the security deposit of the first party terminal are assigned to the second party terminal so as to encourage the first party terminal to release the random value S timely.

In some embodiments of the present invention, a quiz game processing method and system thereof is provided for recording the quiz game request information of both the first and second party terminals in the blockchain so as to protect the quiz game request information be non-tamperable to ensure the fairness and impartness of the quiz game.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is a flow chart of a quiz game processing method according to a preferred embodiment of the present invention.

FIG. 2 is a flow chart of the step S3 of the method of FIG. 1 according to a preferred embodiment of the present invention.

FIG. 3 is a flow chart of the step S3 of the method of FIG. 1 according to another preferred embodiment of the present invention.

FIG. 4 is a flow chart of the method according to the above preferred embodiment of the present invention.

FIG. 5 is a structural schematic view of a system according to a preferred embodiment of the present invention.

FIG. 6 is a structural schematic view of a system according to another preferred embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

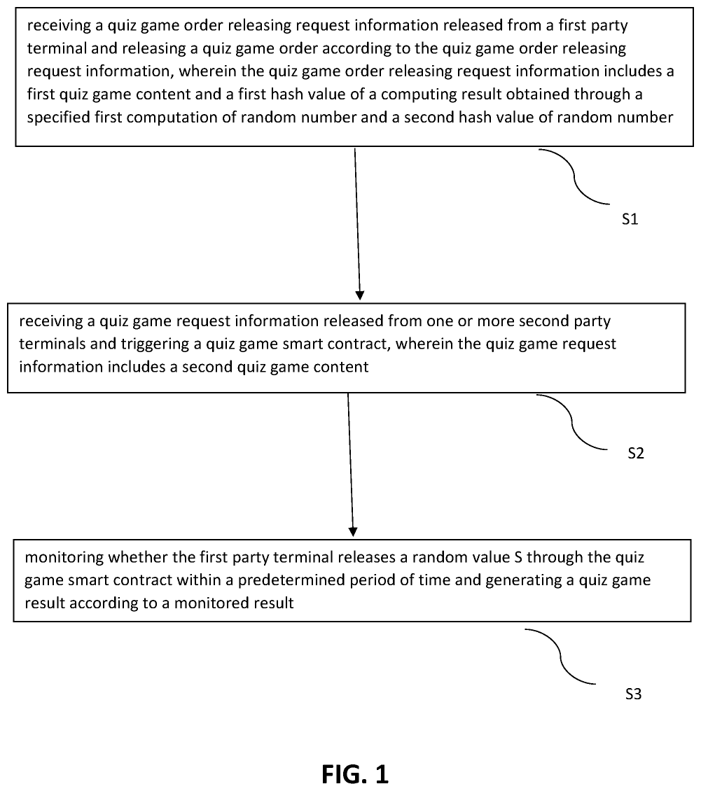

FIG. 1 is a flow chart of a quiz game processing method according to a preferred embodiment of the present invention.

Referring to FIG. 1, according to the present embodiment, the present invention provides a quiz game processing method, including the following steps:

S1: receiving a quiz game order releasing request information released from a first party terminal A and releasing a quiz game order according to the quiz game order releasing request information, wherein the quiz game order releasing request information includes a first quiz game content and a first hash value of a computing result obtained through a specified first computation of random number and a second hash value of random number;

S2: receiving a quiz game request information released from one or more second party terminals B and triggering a quiz game smart contract, wherein the quiz game request information includes a second quiz game content; and

S3: monitoring whether the first party terminal releases a random value S through the quiz game smart contract within a predetermined period of time and generating a quiz game result according to a monitored result.

In particular, taking a finger-guessing game as an example,

In the step S1, the first party terminal A initiates a finger-guessing game (scissors, rock or cloth) by providing a random value s, wherein a second hash value y is obtained by processing a hash operation for the random value s and a computation result X is obtained by a computation method for a first quiz game content, that is the finger type such as rock, and the random value s (rock+s), and then a first hash value x is obtained by processing a hash operation of the computation result X.

In the step S2, when the first hash value x and the second hash value y are received by one or more second party terminals B, the correspondingly second party terminal release a second quiz game content, that is a finger type (such as cloth).

In the step S3, within a predetermined period of time, such as two hours, process a determination for a quiz game result of the first party terminal A and the second party terminal by monitoring if the first party terminal A releases the random value s and generate the quiz game result.

By releasing a hash value to ensure on one other than the first party terminal A knowing the quiz game content of the first party terminal A, wherein the quiz game processing system can only compute the quiz game content of the first party terminal A by means of the random value s so as to effectively prevent cheating during the quiz game.

In other preferred embodiments, the computation method can not only be the computation of the first quiz game content+s (rock+s), but also be the computation of s+the first quiz game content (s+rock), as well as be computing the first quiz game content (rock) and then combining the computation of the two and etc. In other preferred embodiments, the quiz game can be not only the finger-guessing game, but also be other online games such as bigger or smaller number guessing game, crossword puzzles game, playing poker game, and the like, that should not be limited as the exampling game of the preferred embodiments.

In addition, preferably, the quiz game order releasing request information is recorded on the blockchain by a first private key signature held by the first party terminal A, and the quiz game request information is recorded on the blockchain by a second private key signature by the second party terminal.

According to the above preferred embodiment, the first and second private key signatures of the quiz game request information of the first and second party terminals A, B are recorded on the blockchain so as to ensure the truthfulness of their quiz game contents is reliable and non-tamperable.

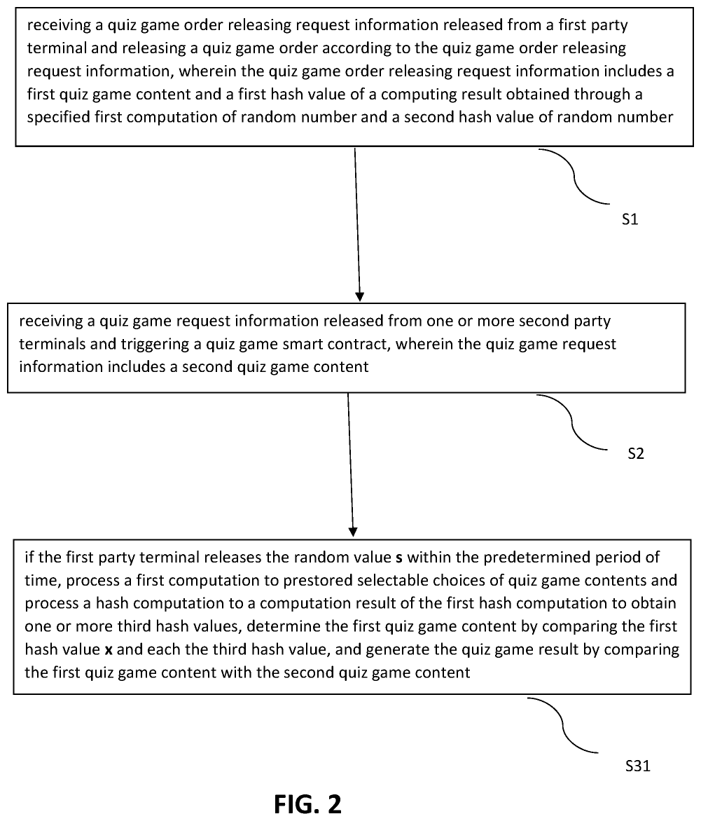

FIG. 2 illustrates the step S3 of the flow chart in FIG. 1 according to the above preferred embodiment.

Referring to FIG. 2, the step S3 includes:

Step S31: if the first party terminal A releases the random value s within the predetermined period of time, process a first computation to prestored selectable choices of quiz game contents and process a hash computation to a computation result of the first hash computation to obtain one or more third hash values, determine the first quiz game content by comparing the first hash value x and each the third hash value, and generate the quiz game result by comparing the first quiz game content with the second quiz game content.

If no random value is received from the first party terminal A within the predetermined period of time, determine a winning for the second party terminal B directly and generate the quiz game result.

In particular, within the predetermined period of time, such as two hours, if the first party terminal A releases the random value s, the quiz game processing system would process the first computation operation by reviewing the prestored quiz game contents (cloth, rock, scissors) and the random value s. After three computation results are obtained, process the three computation results for a hashing operation to obtain three hash values respectively. Then, when a quiz game content which is the same of the first hash value x is obtained by comparing the three hash values with the first hash value x, the quiz game result is generated through determining such quiz game content with the second quiz game content. If no random value released by the first party terminal A is received within the predetermined period of time, determine a winning for the second party terminal B directly that is not changeable even though the first party terminal A releases the random value s thereafter.

The above preferred embodiment discloses a determination of who is the winning party between the first and second party terminals A, B by whether the first party terminal A releases the random value s, that further improves the quiz game content and the way of determining the quiz game result.

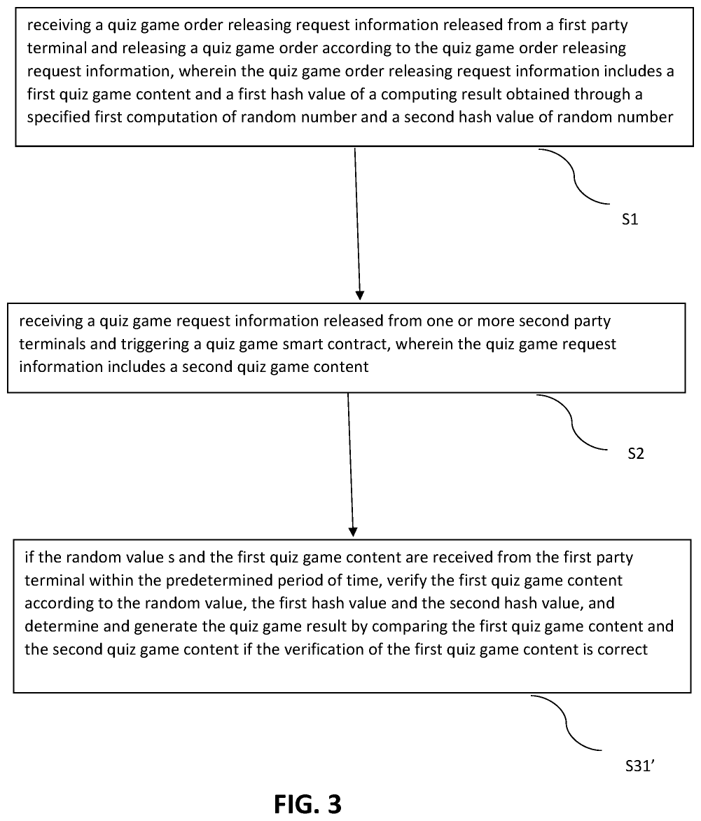

FIG. 3 is a flow chart of the step S3 as shown in FIG. 1 according to the preferred embodiment, wherein the step S3 includes:

Step 31′: if the random value s and the first quiz game content are received from the first party terminal A within the predetermined period of time, verify the first quiz game content according to the random value s, the first hash value x and the second hash value y, and determine and generate the quiz game result by comparing the first quiz game content and the second quiz game content if the verification of the first quiz game content is correct.

If no random value s and the first quiz game content is received within the predetermined period of time, determine a winning for the second party terminal B directly and generate the quiz game result.

In particular, within the predetermined period of time, if the random value s and the first quiz game content are received from the first party terminal A, the quiz game processing system would generate a second hash value b according to the released random value s and generate a computation result according to the first computation operation for the random value s and the first quiz game content, so as to obtain the first hash value a by processing the hash computation for the computation operation. Then, verify whether the hash values a, b is the same of the first hash value x and the second hash value y. If verification is correct, then the first quiz game content is determined, and the quiz game result is generated by determining the first quiz game content and the second quiz game content. If no random value s and the first quiz game content is received with the predetermined period of time, determine a winning for the second party terminal B directly.

The above preferred embodiment determines the quiz game result by whether the first party terminal releases the random value s and the first quiz game content to improve the obtain of the first quiz game content and the way of determining the first quiz game result.

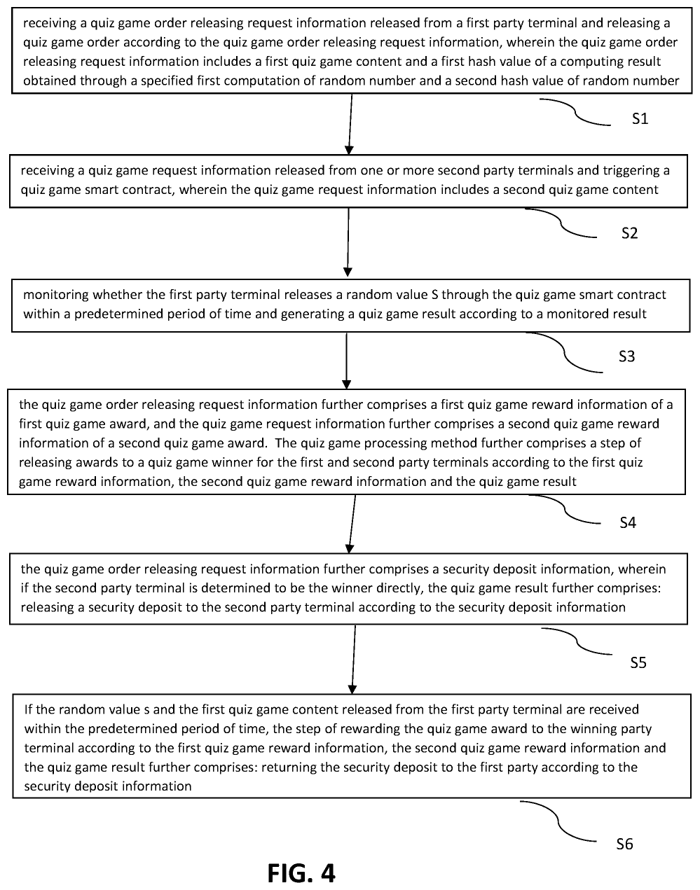

FIG. 4 is a flow chart of the preferred embodiment as illustrated in FIG. 1.

Referring to FIG. 4, the quiz game processing method further comprise:

Step S4: The quiz game order releasing request information further comprises a first quiz game reward information of a first quiz game award, and the quiz game request information further comprises a second quiz game reward information of a second quiz game award. The quiz game processing method further comprises a step of releasing awards to a quiz game winner for the first and second party terminals according to the first quiz game reward information, the second quiz game reward information and the quiz game result.

Preferably, the quiz game processing method further comprises:

Step S5: the quiz game order releasing request information further comprises a security deposit information, wherein if the second party terminal B is determined to be the winner directly, the quiz game result further comprises: releasing a security deposit to the second party terminal B according to the security deposit information.

Further, preferably, the quiz game processing method further comprises:

Step S6: If the random value s and the first quiz game content released from the first party terminal A are received within the predetermined period of time, the step of rewarding the quiz game award to the winning party terminal according to the first quiz game reward information, the second quiz game reward information and the quiz game result further comprises: returning the security deposit to the first party terminal A according to the security deposit information.

In particular, when the first party terminal releases the quiz game order releasing request information, the quiz game request information, besides the first hash value x and the second hash value y, further comprises a first quiz game rewarding information (such as 30 points) and the security deposit (such as 30 points), wherein one of the second party terminals B releases the quiz game request information after receiving the two hash values x, y and the 30 points, i.e. releasing the second quiz game content, i.e. type of fingers (such as cloth), as well as the second quiz game rewarding information (30 points). Then, if the random value s released from the first party terminal A is received and the first quiz game content of the first party terminal A is computed out (i.e. rock), then the second party terminal B is determined as the winning part. At that time, the quiz game smart contract will assign the 30 points from the first party terminal A to the second party terminal B and also return the security deposit 30 points to the first party terminal A. If no random value s is released within the predetermined period of time, the second party terminal B is determined as the winning party and the quiz game smart contract would assign the 30 points to the second party terminal B and also assign the security deposit to the second party terminal B as penalty.

The above preferred embodiment better urges the first party terminal A to release random value s within the predetermined period of time by providing certain quiz game rewarding and punishing rules.

In other preferred embodiments, the quiz game award is not limited to the way of integration points as disclosed above, it may also be game coins or in other formats. The quiz game award for both first and second party terminals can be the same or in different forms, or other forms such as being doubled. The security deposit can be the same of the quiz game rewarding or in different forms, for example while the quiz game award is integration points, the security deposit can be points, game coins or other forms, that should not be limiting in the present invention.

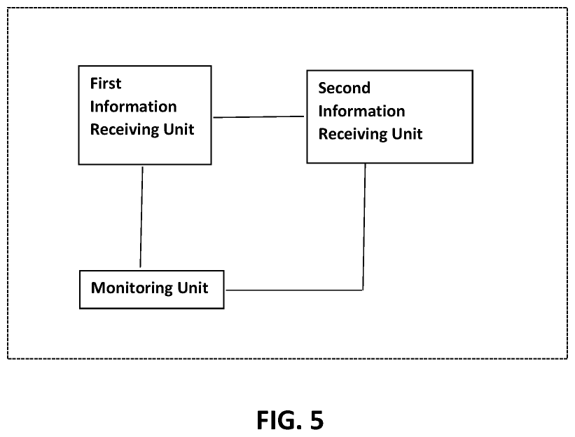

FIG. 5 illustrates a schematic view of a system according to a preferred embodiment of the present invention.

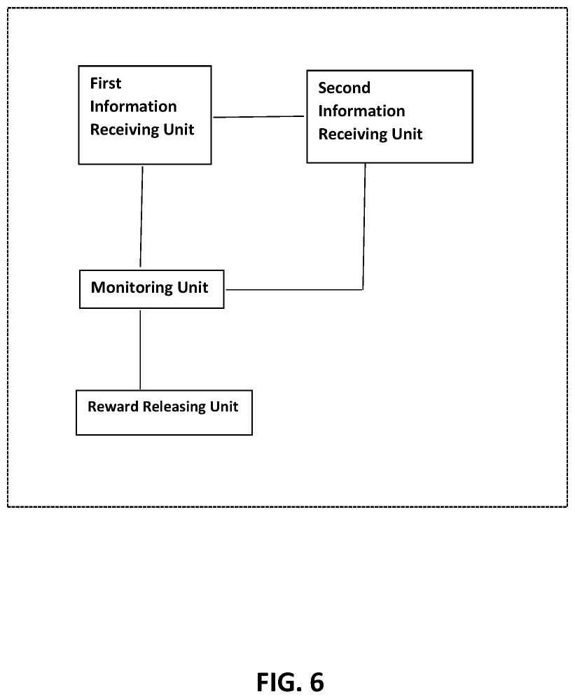

Referring to FIG. 6, a quiz game processing system comprises:

a first information receiving unit, receiving the quiz game order releasing information from the first party terminal A and releasing the quiz game order according to the quiz game order releasing information, wherein the quiz game order releasing information includes a first quiz game content and a first hash value x of random value of a computation result of a specific first computation, and a second hash value of random value y;

a second information receiving unit, receiving a quiz game request information from one or more second party terminals B in response to the quiz game request information of the quiz game order, and triggering the quiz game smart contract, wherein the quiz game request information includes the second quiz game content; and

a monitoring unit, arranged for monitoring whether the first party terminal A releases the random value within a predetermined period of time through the quiz game smart contract, so as to generate a quiz game result according to a monitoring result.

Further, preferably, the monitoring unit further comprises:

a determining sub-unit, arranged for processing a first computation to prestored selectable choices of quiz game contents and the random value if the random value released from the first party terminal A is received within the predetermined period of time, processing a hash computation to a computation result of the first hash computation to obtain one or more third hash values, determining the first quiz game content by comparing the first hash value x and the third hash values, and generating the quiz game result by comparing the first quiz game content with the second quiz game content, wherein if no random value released from the first party terminal A is received, the second party terminal B is determined as winning and the quiz game result is generated.

Or, if the random value and the first quiz game content released from the first party terminal A are received within the predetermined period of time, the first quiz game content is verified according to the random value, the first hash value x and the second hash value y, and the quiz game result is generated after a determination by comparing the first quiz game content with the second quiz game content is verified to be correct. If no random value released from the first party terminal A is received within the predetermined period of time, the second party terminal B is determined as winning and the quiz game result is generated.

FIG. 6 illustrates a schematic view of the system as shown in FIG. 5 according to the preferred embodiment of the present invention.

Referring to FIG. 6, the quiz game processing system further comprises:

a reward releasing unit, arranged for releasing award to a winner of the first or second party terminal according to the first quiz game rewarding information, the second quiz game rewarding information and the quiz game result.

Further, preferably, the reward releasing unit further comprises a security deposit information sub-unit arranged for releasing the security deposit to the second party terminal B as penalty according to the security deposit information, or returning the security deposit to the first party terminal A according to the security deposit information.

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

1. A quiz game processing method, comprising:
(S1) receiving a quiz game order releasing request information released from a first party terminal and releasing a quiz game order according to the quiz game order releasing request information, wherein the quiz game order releasing request information includes a first quiz game content and a first hash value of a computing result obtained through a specified first computation of random number, and a second hash value of random number;
(S2) receiving a quiz game request information released from one or more second party terminals and triggering a quiz game smart contract, wherein the quiz game request information includes a second quiz game content; and
(S3) monitoring whether the first party terminal releases a random value S through the quiz game smart contract within a predetermined period of time and generating a quiz game result according to a monitored result.

2. The quiz game processing method, as recited in claim 1, wherein the step (S3) further comprises the steps of:
(S31) if the random value released from the first party terminal is received within the predetermined period of time, processing a first computation to prestored selectable choices of quiz game contents, processing a hash computation to a computation result of the first hash computation to obtain one or more third hash values, determining the first quiz game content by comparing the first hash value with the one or more third hash values, and generating the quiz game result by determining the first quiz game content with the second quiz game content; and
(S32) if no random value is received from the first party terminal within the predetermined period of time, determining the second party terminal as a winning party directly and generating the quiz game result.

3. The quiz game processing method, as recited in claim 1, wherein the step (S3) further comprises the steps of:
(S31) if the random value and the first quiz game content from the first party terminal are received within the predetermined period of time, verifying the first quiz game content according to the random value, the first hash value and the second hash value, and determining and generating the quiz game result by comparing the first quiz game content and the second quiz game content if the verification of the first quiz game content is correct; and
(S32) if no random value and the first quiz game content is received within the predetermined period of time, determining the second party terminal as a winning party directly and generating the quiz game result.

4. The quiz game processing method, as recited in claim 2, wherein the quiz game order releasing request information further comprises a first quiz game reward information of a first quiz game award, and the quiz game request information further comprises a second quiz game reward information of a second quiz game award, wherein the quiz game processing method further comprises a step of releasing a quiz game award to a winning party of the first and second party terminals according to the first quiz game rewarding information, the second quiz game rewarding information and the quiz game result.

5. The quiz game processing method, as recited in claim 4, wherein the quiz game order releasing request information further comprises a security deposit information, and that the step of determining the second party terminal as the winning party and generating the quiz game result directly further comprises a step of:
releasing a security deposit to the second party terminal according to the security deposit information.

6. The quiz game processing method, as recited in claim 5, wherein if the random value released from the first party terminal is received, the step of releasing the quiz game award to the winning party according to the first quiz game rewarding information, the second quiz game rewarding information and the quiz game result further comprises a step of:
returning the security deposit to the first party terminal according to the security deposit information.

7-10. (canceled)

11. The quiz game processing method, as recited in claim 3, wherein the quiz game order releasing request information further comprises a first quiz game reward information of a first quiz game award, and the quiz game request information further comprises a second quiz game reward information of a second quiz game award, wherein the quiz game processing method further comprises a step of releasing a quiz game award to a winning party of the first and second party terminals according to the first quiz game rewarding information, the second quiz game rewarding information and the quiz game result.

12. The quiz game processing method, as recited in claim 11, wherein the quiz game order releasing request information further comprises a security deposit information, and that the step of determining the second party terminal as the winning party and generating the quiz game result directly further comprises a step of:
releasing a security deposit to the second party terminal according to the security deposit information.

13. The quiz game processing method, as recited in claim 12, wherein if the random value released from the first party terminal is received, the step of releasing the quiz game award to the winning party according to the first quiz game rewarding information, the second quiz game rewarding information and the quiz game result further comprises a step of:
returning the security deposit to the first party terminal according to the security deposit information.

14. A quiz game processing system, comprising:
a first information receiving unit, receiving a quiz game order releasing information from the first party terminal and releasing a quiz game order according to the quiz game order releasing information, wherein the quiz game order releasing information includes a first quiz game content and a first hash value of random value of a computation result of a specific first computation, and a second hash value of random value;
a second information receiving unit, receiving a quiz game request information from one or more second party terminals in response to the quiz game request information of the quiz game order, and triggering a quiz game smart contract, wherein the quiz game request information includes a second quiz game content; and
a monitoring unit, arranged for monitoring whether the first party terminal releases the random value within a predetermined period of time through the quiz game smart contract, so as to generate a quiz game result according to a monitoring result.

15. The quiz game processing system, as recited in claim 14, wherein the monitoring unit further comprises:
a determining sub-unit, arranged to process a first computation to prestored selectable choices of quiz game contents and the random value if the random value released from the first party terminal is received within the predetermined period of time, process a hash computation to a computation result of the first hash computation to obtain one or more third hash values, determine the first quiz game content by comparing the first hash value and the third hash values, and generate the quiz game result by comparing the first quiz game content with the second quiz game content, wherein if no random value released from the first party terminal is received, the second party terminal is determined as winning and the quiz game result is generated.

16. The quiz game processing system, as recited in claim 14, wherein if the random value and the first quiz game content released from the first party terminal are received within the predetermined period of time, the first quiz game content is verified according to the random value, the first hash value and the second hash value, and the quiz game result is generated after a determination by comparing the first quiz game content with the second quiz game content is verified to be correct.

17. The quiz game processing system, as recited in claim 16, wherein if no random value released from the first party terminal is received within the predetermined period of time, the second party terminal is determined as winning and the quiz game result is generated.

18. The quiz game processing system, as recited in claim 14, further comprising a reward releasing unit, arranged to release award to a winner of the first or second party terminal according to the first quiz game rewarding information, the second quiz game rewarding information and the quiz game result.

19. The quiz game processing system, as recited in claim 15, further comprising a reward releasing unit, arranged to release award to a winner of the first or second party terminal according to the first quiz game rewarding information, the second quiz game rewarding information and the quiz game result.

20. The quiz game processing system, as recited in claim 17, further comprising a reward releasing unit, arranged to release award to a winner of the first or second party terminal according to the first quiz game rewarding information, the second quiz game rewarding information and the quiz game result.

21. The quiz game processing system, as recited in claim 18, wherein the reward releasing unit further comprises a security deposit information sub-unit arranged to release the security deposit to the second party terminal as penalty according to the security deposit information, or to return the security deposit to the first party terminal according to the security deposit information.

22. The quiz game processing system, as recited in claim 19, wherein the reward releasing unit further comprises a security deposit information sub-unit arranged to release the security deposit to the second party terminal as penalty according to the security deposit information, or to return the security deposit to the first party terminal according to the security deposit information.

23. The quiz game processing system, as recited in claim 20, wherein the reward releasing unit further comprises a security deposit information sub-unit arranged to release the security deposit to the second party terminal as penalty according to the security deposit information, or to return the security deposit to the first party terminal according to the security deposit information.
